(19) United States
(12) Patent Application Publication
(10) Pub. No.: US 2019/0131923 A1
(43) Pub. Date: May 2, 2019

(54) DEMAND CHARGE MINIMIZATION AND PV UTILIZATION MAXIMIZATION

(71) Applicant: NEC Laboratories America, Inc., Princeton, NJ (US)

(72) Inventors: Ali Hooshmand, San Jose, CA (US); Ratnesh Sharma, Fremont, CA (US); Mohammad Ehsan Raoufat, Raliegh, NC (US); Ramin Moslemi, Sunnyvale, CA (US)

(21) Appl. No.: 16/173,265

(22) Filed: Oct. 29, 2018

Related U.S. Application Data
(60) Provisional application No. 62/578,567, filed on Oct. 30, 2017.

(51) Int. Cl. H02S 40/38; H01M 10/46; H01M 10/44; H01M 10/42; H02J 7/00

(52) U.S. Cl. CPC H02S 40/38; H01M 10/465; H01M 2010/4271; H01M 10/425; H02J 7/008; H01M 10/44

(57) ABSTRACT

A computer-implemented method is provided for controlling a Battery Energy Storage System (BESS) having a battery set and connected to a Photovoltaic (PV) panel set. The method includes enforcing, by a processor device, a multi-objective Model Predictive Control (MPC) optimization on the BESS. The multi-objective MPC optimization includes a first objective of reducing a possibility of Demand Charge Threshold violations by minimal DCT increments which provide a higher demand charge savings, a second objective of improving a robustness of the BESS against energy forecast errors by increasing a State Of Charge (SOC) of the battery set, and a third objective of maximizing PV-utilization. The method further includes controlling, by the processor device, charging and discharging of the BESS in accordance with the multi-objective MPC optimization to meet the first, second, and third objectives.

### RELATED APPLICATION INFORMATION

This application claims priority to U.S. Provisional Application No. 62/578,567, filed on Oct. 30, 2017, incorporated herein by reference herein its entirety.

### BACKGROUND

### Technical Field

The present invention relates to management of energy storage systems, and more particularly to demand charge minimization and PV utilization maximization in energy storage systems.

### Description of the Related Art

The economic benefits of Battery Energy Storage Systems (BESSs) can be improved by providing auxiliary services. A key point is that while the benefit/cost ratio for a single application may not be favorable, stacked services can provide multiple revenue streams for the same investment. Ultimately, the effectiveness of this concept mainly relies on the extent to which cooperative interaction exists among these services. In most recent applications, BESSs are typically assigned and dispatched according to a single primary objective such as demand charge (DC) management.

Meanwhile, growing penetration of rooftop Photovoltaic (PV) generation is causing operational challenges for utility companies to keep the voltage within an acceptable range. From the utility's point of view, maximizing the local PV-utilization reduces voltage fluctuations, improves power quality, and minimizes the loss in distribution networks. Additionally, Commercial and Industrial (C&I) customers with battery storage systems can benefit from incentive support programs for self-consumption, prevent curtailment loss due to feed-in limitations, and avoid the reduced PV feed-in tariff while providing Direct Current (DC) services at the same time. The challenge in combining DC management and PV-utilization service lies in their opposing nature: DC reduction works better when a BESS is fully charged and ready to shave the peak, while PV-utilization prefers a battery which is not fully charged and is ready to store the excess generation. The problem is to find the optimal charging and discharging profiles to minimize the DC cost and enhance the PV-utilization. Hence, there is a need for an improved approach for demand charge minimization and PV utilization maximization.

### SUMMARY

According to an aspect of the present invention, a computer-implemented method is provided for controlling a Battery Energy Storage System (BESS) having a battery set and connected to a Photovoltaic (PV) panel set. The method includes enforcing, by a processor device, a multi-objective Model Predictive Control (MPC) optimization on the BESS. The multi-objective MPC optimization includes a first objective of reducing a possibility of Demand Charge Threshold violations by minimal DCT increments which provide a higher demand charge savings, a second objective of improving a robustness of the BESS against energy forecast errors by increasing a State Of Charge (SOC) of the battery set, and a third objective of maximizing PV-utilization. The method further includes controlling, by the processor device, charging and discharging of the BESS in accordance with the multi-objective MPC optimization to meet the first, second, and third objectives.

According to another aspect of the present invention, a computer program product is provided for controlling a Battery Energy Storage System (BESS) having a battery set and connected to a Photovoltaic (PV) panel set. The computer program product includes a non-transitory computer readable storage medium having program instructions embodied therewith. The program instructions are executable by a computer to cause the computer to perform a method. The method includes enforcing, by a processor device, a multi-objective Model Predictive Control (MPC) optimization on the BESS. The multi-objective MPC optimization includes a first objective of reducing a possibility of Demand Charge Threshold violations by minimal DCT increments which provide a higher demand charge savings, a second objective of improving a robustness of the BESS against energy forecast errors by increasing a State Of Charge (SOC) of the battery set, and a third objective of maximizing PV-utilization. The method further includes controlling, by the processor device, charging and discharging of the BESS in accordance with the multi-objective MPC optimization to meet the first, second, and third objectives.

According to yet another aspect of the present invention, a computer-implemented method is provided for controlling a Battery Energy Storage System (BESS) having a battery set and connected to a Photovoltaic (PV) panel set. The method includes preventing, by a processor device, a loss of Demand charge (DC) savings caused by PV-utilization events and load and PV forecast errors as an objective by enforcing a constraint on the BESS that a specific portion of a battery state of charge (SOC_{PVU}), from a total amount of battery storage, is usable only for PV-utilization. The method further includes controlling, by the processor device, charging and discharging of the battery set in accordance with the constraint to meet the objective.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating an exemplary processing system to which the present principles may be applied, in accordance with the present principles;

FIG. 2 is a block diagram showing an exemplary Behind The Meter (BTM) Demand Charge Management System (DCMS) with a Photovoltaic (PV) utilization feature for a typical industrial/commercial customer equipped with PV generation units, in accordance with an embodiment of the present invention;

FIG. 3 is a flow diagram showing an exemplary method for implementing a first configuration of a daily layer demand charge and PV utilization integrated controller, in accordance with an embodiment of the present invention; and

FIG. 4 is a flow diagram showing an exemplary method for implementing a first configuration of a daily layer demand charge and PV utilization integrated controller, in accordance with an embodiment of the present invention.

### DETAILED DESCRIPTION OF PREFERRED EMBODIMENTS

The present invention is directed to demand charge minimization and Photovoltaic (PV) utilization maximization.

In an embodiment, the present invention uses historical data to decide about the next month Demand Charge Threshold (DCT) in the monthly layer. A short-term forecast element is developed to predict load profiles and PV generations for the next 24 hours using an ARIMA model or other appropriate artificial intelligence (AI) models with exogenous inputs. Then, a model predictive control (MPC) based scheme is developed to calculate the optimal charging/discharging control commands for 15-minutes intervals. Two different solutions are proposed to improve the trade-off between Demand Charge (DC) savings and PV-utilization rate. Applying the proposed multi-objective energy management system maximizes Commercial and Industrial (C&I) customers DC savings while optimizing the local usage of the PV units. The proposed approach prevents/reduces the PV sell back or curtailment by storing the excess PV in the battery storage and using the stored energy for peak shaving.

One advantage of the present invention is in recording historical load and PV generation data which will be used to decide about the next month's DCT in the monthly layer. Using the required historical data to train the forecast models of the PV generation or demand profiles and using the seasonal ARIMAs or an AI based forecast models with exogenous inputs, an approach is provided in accordance with the present invention that improves the charge savings and PV utilization rate and makes a tradeoff between the two competing objectives. In a first solution in accordance with an embodiment of the present invention, a multi-objective MPC optimization framework is proposed in which all the objectives are solved at the same time using a total battery capacity. In a second solution in accordance with an embodiment of the present invention, a portion of the battery will be assigned for PV-utilization and the remainder will be used for demand charge management.

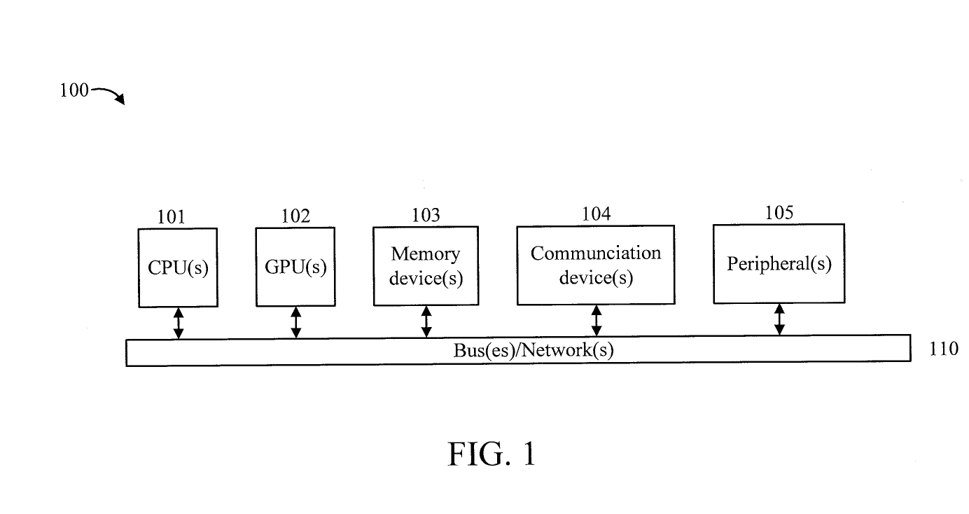

FIG. 1 is a block diagram showing an exemplary processing system 100 to which the present invention may be applied, in accordance with an embodiment of the present invention. The processing system 100 includes a set of processing units (e.g., CPUs) 101, a set of GPUs 102, a set of memory devices 103, a set of communication devices 104, and set of peripherals 105. The CPUs 101 can be single or multi-core CPUs. The GPUs 102 can be single or multi-core GPUs. The one or more memory devices 103 can include caches, RAMs, ROMs, and other memories (flash, optical, magnetic, etc.). The communication devices 104 can include wireless and/or wired communication devices (e.g., network (e.g., WIFI, etc.) adapters, etc.). The peripherals 105 can include a display device, a user input device, a printer, an imaging device, and so forth. Elements of processing system 100 are connected by one or more buses or networks (collectively denoted by the figure reference numeral 110).

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 100.

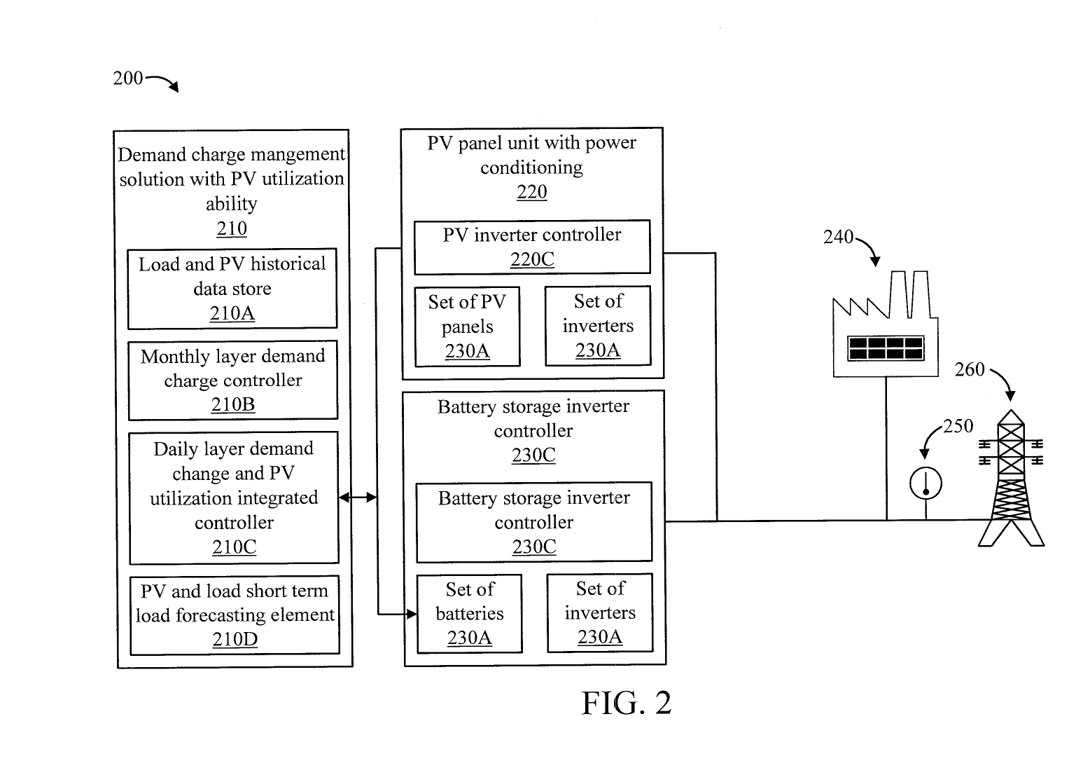

FIG. 2 is a block diagram showing an exemplary Behind The Meter (BTM) Demand Charge Management System (DCMS) 200 with a Photovoltaic (PV) utilization feature for a typical industrial/commercial customer equipped with PV generation units, in accordance with an embodiment of the present invention. That is, FIG. 2 shows an industrial unit equipped with PV panel unit and a BTM battery storage unit. The BTM battery storage unit is responsible for reducing the demand charge and improving the PV-utilization at the same time as described herein.

The BTM DCMS 200 includes a Demand Charge Management (DCM) solution with PV utilization ability portion 210, a PV panel unit with power conditioning 220, a battery storage inverter controller 230, an industrial unit 240, a meter 250, and a distribution grid 260.

The batter storage inverter controller 230 includes a set of batteries 230A, a set of inverters 230B, and a battery storage inverter controller 230C.

The PV panel unit with power conditioning 220 includes a set of Photovoltaic (PV) panels 220A, a set of inverters 220B, and a PV inverter controller 220C.

The industrial unit 240 includes multiple loads.

The DCM solution with PV utilization ability portion 210 includes a load and PV historical data set/store (hereinafter “load and PV historical data store” in short) 210A, a monthly layer demand charge controller 210B, a daily layer demand charge and PV utilization integrated controller 210C, and a PV and load short term load forecasting element 210D.

The DCM solution with PV utilization ability portion 210 is configured to realize the following two objectives: (1) reduce the monthly demand charge; and (2) increase the PV-utilization and reduce the power sell back to the grid by providing appropriate charge or discharge commands to the battery storage units.

The DCM solution with PV utilization ability portion 210 can be implemented by a processor device(s) and corresponding memory(s). In an embodiment, one or more Application Specific Integrated Circuits (ASICs) can be used to implement at least part of the DCM solution with PV utilization ability portion 210. Moreover, specialized and/or dedicated databases can also be part of the DCM solution with PV utilization ability portion 210. Of course, other devices and implementations can also be used, while maintaining the spirit of the present invention.

A novel feature of DCM solution with PV utilization ability portion 210 is to provide coordination between the battery storage unit 230 and the PV panel unit 220 in order to optimize both of the aforementioned objectives at the same time.

The load and PV historical data store 210A records the historical load and PV generation data which will be used to decide about the next month DCT in the monthly layer. Also, the load and PV historical data store 210A sends the required historical data to the PV and load short term load forecasting element 210D to train the forecast models of PV generation and demand profiles.

The monthly layer demand charge controller 210B uses the history of the load and PV (last month) to estimate the DCT for the upcoming billing period. Outputs of the monthly layer demand charge controller 210B are the next billing period DCT estimation which will be sent to the daily layer demand charge and PV utilization integrated controller 210C as reference thresholds.

The PV and load short term load forecasting element 210D represents the short term forecast elements for the load profiles and PV generations. The PV and load short term load forecasting element 210D receives the required historical data and exogenous inputs (i.e., temperature and cloud coverage forecasts) for the training and forecast purposes from the block 210A and external resources respectively. The PV and load short term load forecasting element 210 uses the seasonal ARIMA model with exogenous inputs to forecast the load and PV in the next 24 hours. The outputs of the PV and load short term load forecasting element 210 are sent to the daily layer demand charge and PV utilization integrated controller 210C for DCT modification and PV-utilization.

The daily layer demand charge and PV utilization integrated controller 210C is responsible to realize or modify the DCT values based on the next 24 hours load and PV generation forecasted profiles to prevent probable DCT violations and avoid the demand charge saving deterioration. Also, the daily layer demand charge and PV utilization integrated controller 210C provides the charge and discharge schedule for the battery real-time controller to keep the imported power below the obtained DCT values and maximize the PV-utilization as the secondary objective. These two objectives could be optimized concurrently with an acceptable trade-off (DC and PV-utilization events occur at the different time during the day) if the short term load and PV forecast profiles are accurate. However, for the case that these forecasted profiles are not accurate, making the trade-off between these two objectives could be challenging and it is possible to lose the significant part of the monthly DC saving due to prediction error. To deal with these challenges, two solutions are proposed for the daily layer demand charge and PV utilization integrated controller 210C.

A description will now be given regarding a first solution relating to a first configuration of the daily layer demand charge and PV utilization integrated controller, in accordance with an embodiment of the present invention.

In the first solution, a multi-objective MPC optimization framework is proposed in which three sets of objectives are considered as follows:

(1) Minimizing Demand Charge Thresholds (DCTs) increment to prevent DCT violations;
(2) Increasing battery state of charge (SOC) to improve the robustness against forecast errors; and

### (3) Maximizing PV-utilization,

The second objective function is added to make the system robust against unexpected net load peaks and prevent complete battery depletion for the PV-utilization. In other words, the second objective (function) forces the battery to be charged before each peak while the third objective (function) tries to maximize the PV-utilization during PV excess generation periods. The formulation of the proposed optimization is as follows:

$${min}_{{P}_{s}} ( {α}_{any} Δ {DCT}_{any} + {α}_{par} Δ {DCT}_{par} + {α}_{pea} Δ {DCT}_{pea} ) + {\sum }_{{t}_{0}}^{T + {t}_{0}} β SOC ( t ) + {\sum }_{{t}_{0}}^{T + {t}_{0}} ϒ {P}_{sell} ( t )$$

st.

Pg(t)≤DCT_{any}∀t∈[t₀,T+t₀]

Pg(t)≤DCTₚₐᵣ∀t∈Tₚₐᵣ∩[t₀,T+t₀]

Pg(t)≤DCTₚₐᵣ∀t∈Tₚₐᵣ∩[t₀,T+t₀]

SOC_{b}^{min}≤SOC_{b}(t)≤SOC_{b}^{max}∀t∈[t₀,T+t₀]

P_{b}^{min}≤P_{b}(t)≤P_{b}^{max}∀t∈[t₀,T+t₀]

P_{g}(t)+P_{b}(t)=\tilde{p}_{d}(t)+\tilde{p}ₚᵥ(t)∀t∈[t₀,T+t₀]

SOC_{b}(t)=SOC_{b}(t−1)+ΔtxP_{b}(t)∀t∈[t₀,T+t₀]

DCT_{any}=DCT_{any}⁰+ΔDCT_{any}

DCTₚₐᵣ=DCTₚₐᵣ⁰+ΔDCTₚₐᵣ

DCTₚₑₐ=DCTₚₑₐ⁰+ΔDCTₚₑₐ

ΔDCT_{any},ΔDCTₚₐᵣ⁰,ΔDCTₚₑₐ≥0

Pₛₑₗₗ(t)≥0 ∀t∈[t₀,T+t₀]

P_{g}(t)+Pₛₑₗₗ(t)≥0 ∀t∈[t₀,T+t₀]

The above optimization is solved at each time step. Based on the results of the optimization, DCT values can be updated (to prevent violation) and the optimal battery charged/discharged profiles will be calculated. This will keep the net power bellow the DCT values and increases the PV-utilization.

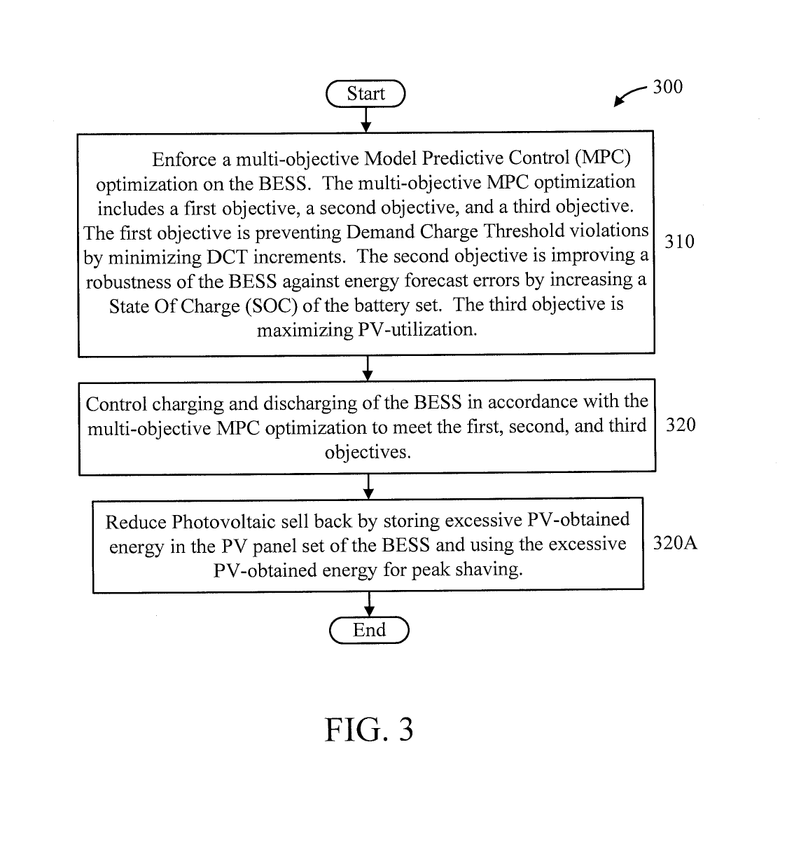

FIG. 3 is a flow diagram showing an exemplary method 300 for implementing a first configuration of a daily layer demand charge and PV utilization integrated controller, in accordance with an embodiment of the present invention.

At block 310, enforce a multi-objective Model Predictive Control (MPC) optimization on the BESS. The multi-objective MPC optimization includes a first objective, a second objective, and a third objective. The first objective is preventing Demand Charge Threshold violations by minimizing DCT increments. In other words, the proposed optimization increases the demand charge threshold optimally when the current DCTs could not be maintained due to an upcoming major peak load given the battery current state of charge (SOC) thereby preventing possible DCT violations which decrease demand charge savings significantly. The second objective is improving a robustness of the BESS against energy forecast errors by increasing a State Of Charge (SOC) of the battery set. The third objective is maximizing PV-utilization.

In an embodiment, the second objective can be configured to force the battery set to be charged before each peak. In an embodiment, the second objective can be configured to increase the SOC of the battery set. In an embodiment, the third objective can be configured to maximize a PV-utilization during PV excess generation periods. In an embodiment, the system robustness is improved with respect to handling unexpected net load peaks and preventing complete battery depletion for PV-utilization.

At block 320, control charging and discharging of the BESS in accordance with the multi-objective MPC optimization to meet the first, second, and third objectives.

In an embodiment, block 320 can include block 320A.

At block 320A, reduce Photovoltaic sell back by storing excessive PV-obtained energy in the PV panel set of the BESS and using the excessive PV-obtained energy for peak shaving.

A description will now be given regarding a second solution relating to a second configuration of the daily layer demand charge and PV utilization integrated controller, in accordance with an embodiment of the present invention.

In the second solution, to prevent loss of DC savings caused by PV-utilization events and forecasts errors, a specific amount of the battery storage will be specified only for PV-utilization which is called SOC_{PVU}. Hence, this portion of the battery SOC is not considered in the process of monthly DCT calculation in the monthly layer. As a result, and since there is no guarantee that SOC_{PVU} will be fully charged before all peak shavings, in the monthly layer, it is assumed that the battery SOC for demand charge management is as follows: SOC_{DC}=SOCₘₐₓ−SOC_{PVU},

where SOCₘₐₓ denotes a maximum overall SOC for the battery set.

On the other hand, the PV-utilization portion of the battery SOC (SOC_{PVU}) is charged only when the net load is negative to prevent the PV sell back to the grids or curtailment. In contrast with the monthly layer, the amount of SOC from this portion will be available at the time of peak shaving SOC_{PVU}^{ava} (charged by the last PV-utilization period) and could be used during the peak shaving (as the reserve capacity) to help deal with unexpected peaks. The SOC_{PVU} has to be depleted completely during or immediately after peak shaving to be available for the next excess PV period. In comparison with the first solution, the demand charge saving and PV-utilization of the second solution could be smaller, however, the second solution is more robust against forecast errors since these problems have been decoupled.

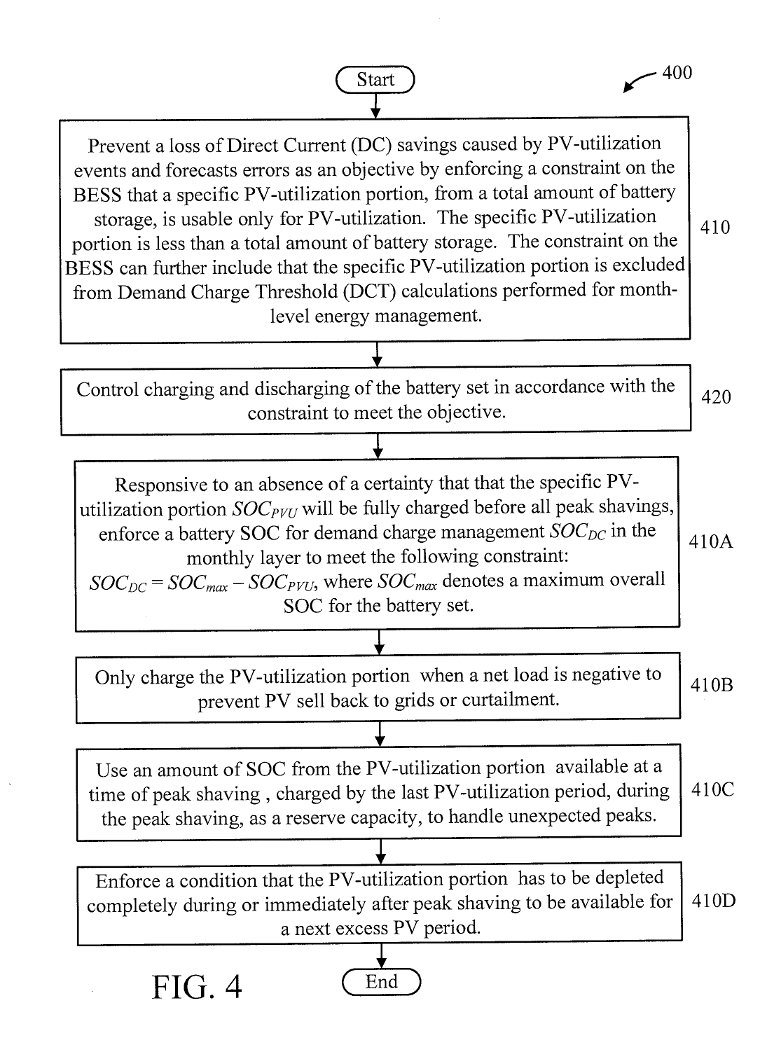

FIG. 4 is a flow diagram showing an exemplary method 400 for implementing a first configuration of a daily layer demand charge and PV utilization integrated controller, in accordance with an embodiment of the present invention.

At block 410, prevent a loss of Demand Charge (DC) savings caused by PV-utilization events and forecasts errors as an objective by enforcing a constraint on the BESS that a specific PV-utilization portion SOC_{PVU}, from a total amount of battery storage, is usable only for PV-utilization. In an embodiment, the specific PV-utilization portion SOC_{PVU} is less than total amount of battery storage. In an embodiment, the constraint on the BESS can further include that the specific PV-utilization portion SOC_{PVU} is excluded from Demand Charge Threshold (DCT) calculations performed for month-level energy management.

In an embodiment, the specific PV-utilization portion of battery energy is usable only for the PV-utilization from among a set of at least two portions of the battery storage SOC. The battery SOC is divided in to at least two portions, the first portion is only useable for PV-utilization while the second portion (or other portions) is (are) used for demand charge savings or other objectives.

At block 420, control charging and discharging of the battery set in accordance with the constraint to meet the objective.

In an embodiment, block 420 can include one or more of blocks 420A-420D.

At block 420A, responsive to an absence of a certainty that the specific PV-utilization portion SOC_{PVU} will be fully charged before all peak shavings, enforce a battery SOC for demand charge management SOC_{DC} in the monthly layer to meet the following constraint: SOC_{DC}=SOCₘₐₓ−SOC_{PVU}, where SOCₘₐₓ denotes a maximum overall SOC for the battery set.

At block 420B, only charge the PV-utilization portion SOC_{PVU} when a net load is negative to prevent PV sell back to grids or curtailment.

At block 420C, in contrast with the monthly layer, use an amount of SOC from the PV-utilization portion SOC_{PVU} available at a time of peak shaving SOC_{PVU}^{ava}, charged by the last PV-utilization period, during the peak shaving, as a reserve capacity, to handle unexpected peaks.

At block 420D, enforce a condition that the PV-utilization portion SOC_{PVU} has to be depleted completely during or immediately after peak shaving to be available for a next excess PV period.

The invention improves the economic benefits of BTM storage systems by providing multiple sources of benefits for same investment in energy storage systems. From the distribution utility's point of view, maximizing the PV-utilization reduces the voltage fluctuations, improves the reliability issues, and minimizes the loss in the distribution network. Additionally, commercial and residential customers can benefit from incentive support programs for self-consumptions, and avoid the reduced PV feed-in tariff while increasing the demand charge savings at the same time.

A description will now be given of some of the myriad of attendant benefits provided by various embodiments of the present invention.

In one or more embodiments, the present invention can help to avoid unnecessary curtailment of PV generation by absorbing the excess energy in case of over generation. Moreover, this method can also reduce the average annual SOC and has the added benefit of increasing the battery lifetime. These and other benefits are provided by the present invention as readily contemplated by one of ordinary skill in the related art based on the teachings of the present invention provided herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for controlling a Battery Energy Storage System (BESS) having a battery set and connected to a Photovoltaic (PV) panel set, the method comprising:
enforcing, by a processor device, a multi-objective Model Predictive Control (MPC) optimization on the BESS, the multi-objective MPC optimization including a first objective of reducing a possibility of Demand Charge Threshold violations by minimal DCT increments which provide a higher demand charge savings, a second objective of improving a robustness of the BESS against energy forecast errors by increasing a State Of Charge (SOC) of the battery set, and a third objective of maximizing PV-utilization;
controlling, by the processor device, charging and discharging of the BESS in accordance with the multi-objective MPC optimization to meet the first, second, and third objectives.

2. The computer-implemented method of claim 1, wherein the system robustness is improved with respect to handling unexpected net load peaks and preventing complete battery depletion for PV-utilization.

3. The computer-implemented method of claim 1, wherein the second objective is configured to force the battery set to be charged before each peak.

4. The computer-implemented method of claim 1, wherein the second objective is configured to increase the SOC of the battery set.

5. The computer-implemented method of claim 1, wherein the second objective is configured to maximize a PV-utilization during PV excess generation periods.

6. The computer-implemented method of claim 1, further comprising reducing Photovoltaic sell back by storing excessive PV-obtained energy in the PV panel set of the BESS and using the excessive PV-obtained energy for peak shaving.

7. A computer program product for controlling a Battery Energy Storage System (BESS) having a battery set and connected to a Photovoltaic (PV) panel set, the computer program product comprising a non-transitory computer readable storage medium having program instructions embodied therewith, the program instructions executable by a computer to cause the computer to perform a method comprising:
enforcing, by a processor device, a multi-objective Model Predictive Control (MPC) optimization on the BESS, the multi-objective MPC optimization including a first objective of reducing a possibility of Demand Charge Threshold violations by minimal DCT increments which provide a higher demand charge savings, a second objective of improving a robustness of the BESS against energy forecast errors by increasing a State Of Charge (SOC) of the battery set, and a third objective of maximizing PV-utilization;
controlling, by the processor device, charging and discharging of the BESS in accordance with the multi-objective MPC optimization to meet the first, second, and third objectives.

8. The computer program product of claim 7, wherein the system robustness is improved with respect to handling unexpected net load peaks and preventing complete battery depletion for PV-utilization.

9. The computer program product of claim 7, wherein the second objective is configured to force the battery set to be charged before each peak.

10. The computer program product of claim 7, wherein the second objective is configured to increase the SOC of the battery set.

11. The computer program product of claim 7, wherein the second objective is configured to maximize a PV-utilization during PV excess generation periods.

12. The computer program product of claim 7, wherein the method further comprises reducing Photovoltaic sell back by storing excessive PV-obtained energy in the PV panel set of the BESS and using the excessive PV-obtained energy for peak shaving.

13. A computer-implemented method for controlling a Battery Energy Storage System (BESS) having a battery set and connected to a Photovoltaic (PV) panel set, the method comprising:
preventing, by a processor device, a loss of Demand charge t (DC) savings caused by PV-utilization events and load and PV forecast errors as an objective by enforcing a constraint on the BESS that a specific portion of a battery state of charge (SOC_{PVU}), from a total amount of battery storage, is usable only for PV-utilization; and
controlling, by the processor device, charging and discharging of the battery set in accordance with the constraint to meet the objective.

14. The computer-implemented method of claim 13, wherein the constraint on the BESS further includes that the specific PV-utilization portion SOC_{PVU} is excluded from Demand Charge Threshold (DCT) calculations performed for month-level energy management.

15. The computer-implemented method of claim 13, wherein, responsive to an absence of a certainty that the specific PV-utilization portion SOC_{PVU} will be fully charged before all peak shavings, the method further comprises enforcing a battery SOC for demand charge management SOC_{DC} in the monthly layer to meet the following constraint: SOC_{DC}=SOCₘₐₓ−SOC_{PVU}, where SOCₘₐₓ denotes a maximum overall SOC for the battery set.

16. The computer-implemented method of claim 13, wherein the PV-utilization portion SOC_{PVU} is charged only when a net load is negative to prevent PV sell back to grids or curtailment.

17. The computer-implemented method of claim 13, in contrast with the monthly layer, an amount of SOC from the PV-utilization portion SOC_{PVU} available at a time of peak shaving SOC_{PVU}^{ava}, charged by the last PV-utilization period, is used during the peak shaving, as a reserve capacity, to handle unexpected peaks.

18. The computer-implemented method of claim 13, further comprising enforcing a condition that the PV-utilization portion of the battery SOC (SOC_{PVU}) has to be depleted completely during or immediately after peak shaving to be available for a next excess PV period.

19. The computer-implemented method of claim 13, wherein the specific PV-utilization portion is usable only for the PV-utilization from among a set of at least two portions of the battery storage SOC, wherein the battery SOC is divided into at least a first portion and a second portion, the first portion being only useable for PV-utilization, the second portion being useable for demand charge savings.

20. The computer-implemented method of claim 13, wherein the specific PV-utilization portion SOC_{PVU} is less than total amount of battery storage.
